(19) United States
(12) Patent Application Publication
(10) Pub. No.: US 2024/0373900 A1
(43) Pub. Date: Nov. 14, 2024

(54) PROCESSES AND SYSTEMS FOR CONVERTING EDIBLE BIOMASS INTO ALTERNATIVE TOBACCO PRODUCTS

(71) Applicant: SUPER CRITICAL IP, LLC., Tempe, AZ (US)

(72) Inventor: Armand J. NOEL, Tempe, AZ (US)

(73) Assignee: SUPER CRITICAL IP, LLC., Tempe, TX (US)

(21) Appl. No.: 18/642,317

(22) Filed: Apr. 22, 2024

Related U.S. Application Data
(60) Provisional application No. 63/500,700, filed on May 8, 2023.

(51) Int. Cl. A24B 15/24; A24B 15/16; B01D 3/18; B01D 11/02

(52) U.S. Cl. CPC A24B 15/24; A24B 15/16; B01D 3/18; B01D 11/0219; B01D 11/028; B01D 11/0288; B01D 11/0296

(57) ABSTRACT

Some variations provide a process for producing an alternative tobacco product from leafy edible biomass, comprising: introducing leafy edible biomass and a liquid solvent mixture to an extraction vessel, wherein the liquid solvent mixture contains a solvent and an anti-solvent; extracting one or more compounds from the biomass into the liquid solvent mixture, to generate a first phase and a second phase; recovering solvent from the second phase, thereby generating recovered solvent; removing one or more compounds from the recovered solvent, thereby generating purified recovered solvent; recycling the purified recovered solvent back to the extraction vessel; drying the first phase to remove residual solvent, thereby generating dried extracted biomass solids and a vapor of the residual solvent; condensing vapor of the residual solvent, thereby generating condensed recovered solvent; recycling the condensed recovered solvent back to the extraction vessel; and recovering the dried extracted biomass solids as an alternative tobacco product.

### REFERENCE TO RELATED APPLICATION

This application claims priority to Provisional Applic. No. 63/500,700, filed May 8, 2023, the contents of which are incorporated herein by reference.

### FIELD OF THE INVENTION

The present invention generally relates to processes and systems for converting cabbage and other types of edible biomass into alternative tobacco products, such as alternative chewing tobacco.

### BACKGROUND OF THE INVENTION

Smoking rates around the world have been driven down by health concerns, increasing regulations, higher prices, and changing social standards. Over the last decade, the promotion of novel and alternative tobacco products has escalated. Traditional smokeless tobacco products, such as loose leaf chewing tobacco and snuff, continue to dominate the smokeless market. Various alternative tobacco products, such as snus, dissolvables, and electronic cigarettes have been promoted as an alternative to traditional tobacco smoking.

Alternative products that are not based on tobacco (referred to herein as “alternative tobacco products”) have been gaining momentum in the marketplace. There is growing demand for alternative tobacco products from consumers looking for a similar experience as from ordinary tobacco but without the downsides of tobacco, such as cancer risks. For example, a known harmful cancer-causing substance in tobacco is tobacco-specific nitrosamine. Also, tobacco stains teeth and causes bad breath. Tobacco can also irritate or destroy gum tissue. There is a strong consumer and societal desire for similar products that do not use tobacco at all, replacing the tobacco with another form of biomass, such as shredded cabbage.

The market for alternative tobacco products is therefore expected to grow significantly in the coming years. Massive market sizes are in play. The global market size for all tobacco products is approximately $900 billion annually, and for chewing tobacco in particular, the global market size is approximately $30 billion-still a very large market.

To address the expected large market size, or even to address a small fraction thereof, there will be a need to process up to millions of pounds of plant biomass per month. A manufacturing process cannot be limited to small laboratory-scale techniques. There are many problems to overcome including, but not limited to, high standard of quality, extraction, solvent purity, and drying.

In view of the market demand and the commercial desires, there is a need for economic, large-scale processes and systems for washing, purifying, and drying biomass to produce alternative tobacco products.

### SUMMARY OF THE INVENTION

The present invention addresses the aforementioned needs in the art, as will now be summarized and then further described in detail below.

Some variations of the invention provide a process for producing an alternative tobacco product from leafy edible biomass, the process comprising:
(a) providing a biomass feedstock comprising leafy edible biomass, wherein the biomass feedstock optionally contains moisture;
(b) introducing the biomass feedstock and a liquid solvent mixture to an extraction vessel, wherein the liquid solvent mixture contains a solvent and an anti-solvent;
(c) extracting one or more compounds from the biomass feedstock into the liquid solvent mixture, within the extraction vessel operated at effective extraction conditions, to generate a first phase and a second phase, wherein the first phase comprises (i) extracted biomass solids and (ii) residual solvent, and wherein the second phase comprises (i) liquid solvent mixture and (ii) the one or more compounds;
(d) recovering at least a portion of the liquid solvent mixture from the second phase, thereby generating recovered solvent;
(e) removing at least a portion of the one or more compounds from the recovered solvent, thereby generating purified recovered solvent;
(f) recycling the purified recovered solvent back to the extraction vessel;
(g) drying the first phase to remove at least a portion of the residual solvent, thereby generating dried extracted biomass solids and a vapor of the residual solvent;
(h) condensing at least a portion of the vapor of the residual solvent, thereby generating condensed recovered solvent;
(i) recycling the condensed recovered solvent back to the extraction vessel; and
(j) recovering the dried extracted biomass solids as an alternative tobacco product.

The leafy edible biomass may be selected from the group consisting of cabbage, kale, celery, broccoli, cauliflower, collard greens, lettuce, spinach, hemp, endive, arugula, chicory, and combinations thereof, for example. In certain embodiments, the leafy edible biomass is cabbage.

In some embodiments, the solvent is water. In some embodiments, the anti-solvent is an alcohol, such as ethanol.

In some embodiments, the extraction vessel has a vertical orientation.

The extraction vessel may contain an inlet filter plate internally situated near the inlet to the extraction vessel, and an outlet filter plate internally situated near the outlet to the extraction vessel. The inlet filter plate and the outlet filter plate allow liquid and vapor to pass but do not allow solid to pass.

In some embodiments, the extraction vessel is configured to recirculate the liquid solvent mixture to increase extraction efficiency.

In some embodiments, the effective extraction conditions include an extraction temperature selected from about −80° C. to about 100° C. during step (c).

In some embodiments, the effective extraction conditions include an extraction time selected from about 5 minutes to about 60 minutes during step (c).

In some embodiments, the effective extraction conditions include an extraction pH selected from about 6 to about 13 during step (c).

In some embodiments, the effective extraction conditions include an extraction pressure selected from about 1 bar to about 5 bar during step (c).

In some embodiments, the effective extraction conditions cause extraction of the one or more compounds at an extraction yield of at least 25%, at least 50%, at least 75%, or at least 90% into the liquid solvent.

In some embodiments, in step (d), at least 80%, at least 90%, or at least 95% of the liquid solvent mixture is recovered from the second phase.

In some embodiments, step (d) uses a falling-film evaporator to recover at least a portion of the solvent from the second phase.

In some embodiments, step (d) uses membrane separation to recover at least a portion of the solvent from the second phase.

The process may further comprise distilling the recovered solvent generated in step (d) to adjust a ratio of the solvent to the anti-solvent within the recovered solvent. Distilling may be done to reduce the ratio of the solvent to the anti-solvent within the recovered solvent. Distilling utilizes a bubble-plate distillation column, in certain embodiments.

In some embodiments, in step (e), at least 50%, at least 75%, at least 90%, or at least 95% of the one or more compounds are removed from the recovered solvent.

In some embodiments, step (e) utilizes pH adjustment of the recovered solvent. The pH of the recovered solvent may be adjusted (or controlled) to be in the range of about 6 to about 13, for example. In these or other embodiments, the liquid solvent mixture has a pH adjusted (or controlled) to be in the range of about 6 to about 13. In these or other embodiments, the purified solvent has a pH adjusted (or controlled) to be in the range of about 6 to about 13. In these or other embodiments, the condensed recovered solvent has a pH adjusted (or controlled) to be in the range of about 6 to about 13.

In some embodiments, step (e) utilizes chromatography to remove at least a portion of the one or more compounds from the recovered solvent. The chromatography may utilize an anion-exchange chromatography resin.

In some embodiments, in step (f), at least 90% of the purified recovered solvent is recycled to the extraction vessel.

In some embodiments, drying in step (g) utilizes a fluidized-bed dryer or utilizes the extraction vessel operated as a fluidized-bed dryer. The fluidized-bed dryer preferably utilizes a heated dryer gas. The heated dryer gas may be selected from the group consisting of air, CO₂, N₂, Ar, He, and combinations thereof.

In some embodiments, in step (g), at least 80%, at least 90%, or at least 95% of the residual solvent is removed from the first phase.

In some embodiments, in step (h), at least 50%, at least 75%, or at least 90% of the vapor of the residual solvent is condensed.

In some embodiments, in step (i), at least 90% of the condensed recovered solvent is recycled to the extraction vessel.

The process may be a batch process. Alternatively, the process may be a continuous or semi-continuous process.

The process may further comprise introducing one or more additives to the alternative tobacco product.

Other variations provide a system for producing an alternative tobacco product from leafy edible biomass, the system comprising:
an extraction vessel configured (a) to receive (i) a biomass feedstock comprising leafy edible biomass and (ii) a liquid solvent mixture, wherein the liquid solvent mixture contains a solvent and an anti-solvent; (b) to operate at effective extraction conditions, in an extraction mode, to extract one or more compounds from the biomass feedstock into the liquid solvent mixture, thereby generating a first phase and a second phase, wherein the first phase comprises (i) extracted biomass solids and (ii) residual solvent, and wherein the second phase comprises (i) liquid solvent mixture and (ii) the one or more compounds; and (c) to operate at effective drying conditions, in a drying mode, to remove the residual solvent, thereby generating dried extracted biomass solids and a vapor of the residual solvent;
a solvent recovery unit in flow communication with the extraction vessel, wherein the solvent recovery unit is configured to recover the solvent from the second phase, thereby generating recovered solvent;
a solvent purification unit in flow communication with the solvent recovery unit, wherein the solvent purification unit is configured to remove the one or more compounds from the recovered solvent, thereby generating purified recovered solvent;
a condenser in flow communication with the extraction vessel, wherein the condenser is configured for condensing the vapor of the residual solvent, thereby generating condensed recovered solvent;
a first solvent-recycle line configured to recycle the purified recovered solvent back to the extraction vessel;
a second solvent-recycle line configured to recycle the condensed recovered solvent back to the extraction vessel; and
a system outlet configured to recover the dried extracted biomass solids as an alternative tobacco product.

In some systems, the extraction vessel has a vertical orientation.

The extraction vessel may contain an inlet filter plate internally situated near the inlet to the extraction vessel, and an outlet filter plate internally situated near the outlet to the extraction vessel. The inlet filter plate and the outlet filter plate allow liquid and vapor to pass but do not allow solid to pass.

The extraction vessel may be configured to recirculate the liquid solvent mixture to increase extraction efficiency.

In some systems, the solvent recovery unit is a falling-film evaporator. In some systems, the solvent recovery unit is a membrane separation unit. In certain systems, both a falling-film evaporator and a membrane separation unit are employed for solvent recovery.

The system may further comprise a distillation unit configured to distill the recovered solvent to adjust a ratio of the solvent (e.g., water) to the anti-solvent (e.g., ethanol) within the recovered solvent. The distillation unit may be a bubble-plate distillation column.

In some systems, the solvent purification unit is a chromatography unit. The chromatography unit may utilize an anion-exchange chromatography resin, for example.

In some systems, the extraction vessel, when in the drying mode, functions as a fluidized-bed dryer. The fluidized-bed dryer preferably utilizes a heated dryer gas (e.g., heated air).

In some systems, the first solvent-recycle line and the second solvent-recycle line are in separate flow communication with the extraction vessel. In other systems, the first solvent-recycle line and the second solvent-recycle line are in combined flow communication with the extraction vessel.

Typically, the system outlet is an outlet directly from the extraction vessel. In a batch system, the extraction vessel itself, when opened for unloading, becomes the outlet. In a continuous system, the extraction vessel may be configured with a bottom port or release valve to recover the dried extracted biomass solids. Alternatively, a forced hot air drum dryer may be positioned at the outlet of the extraction vessel to recover the dried extracted biomass solids. In certain embodiments, the dried extracted biomass solids are conveyed from the extraction vessel to another unit, such as a holding vessel, and then recovered from there, in which case the system outlet is not directly from the extraction vessel.

Other variations provide an alternative tobacco product produced from a process comprising:
(a) providing a biomass feedstock comprising leafy edible biomass, wherein the biomass feedstock optionally contains moisture;
(b) introducing the biomass feedstock and a liquid solvent mixture to an extraction vessel, wherein the liquid solvent mixture contains a solvent and an anti-solvent;
(c) extracting one or more compounds from the biomass feedstock into the liquid solvent mixture, within the extraction vessel operated at effective extraction conditions, to generate a first phase and a second phase, wherein the first phase comprises (i) extracted biomass solids and (ii) residual solvent, and wherein the second phase comprises (i) liquid solvent mixture (i.e., a portion of the initial liquid solvent mixture from step (b)) and (ii) the one or more compounds;
(d) recovering at least a portion of the liquid solvent mixture from the second phase, thereby generating recovered solvent;
(e) removing at least a portion of the one or more compounds from the recovered solvent, thereby generating purified recovered solvent;
(f) recycling the purified recovered solvent back to the extraction vessel;
(g) drying the first phase to remove at least a portion of the residual solvent, thereby generating dried extracted biomass solids and a vapor of the residual solvent;
(h) condensing at least a portion of the vapor of the residual solvent, thereby generating condensed recovered solvent;
(i) recycling the condensed recovered solvent back to the extraction vessel; and
(j) recovering the dried extracted biomass solids as an alternative tobacco product.

In some alternative tobacco products, the leafy edible biomass is selected from the group consisting of cabbage, kale, celery, broccoli, cauliflower, collard greens, lettuce, spinach, hemp, endive, arugula, chicory, and combinations thereof. In certain embodiments, the leafy edible biomass is cabbage.

In some embodiments of alternative tobacco products, the solvent is water and the anti-solvent is an alcohol, such as ethanol.

In some embodiments of alternative tobacco products, the extraction vessel has a vertical orientation.

In some embodiments of alternative tobacco products, the extraction vessel contains an inlet filter plate internally situated near the inlet to the extraction vessel, the extraction vessel contains an outlet filter plate internally situated near the outlet to the extraction vessel, and the inlet filter plate and the outlet filter plate allow liquid and vapor to pass but do not allow solid to pass.

In some embodiments of alternative tobacco products, the extraction vessel is configured to recirculate the liquid solvent mixture to increase extraction efficiency.

In some embodiments of alternative tobacco products, the effective extraction conditions include an extraction temperature selected from about −80° C. to about 100° C. during step (c).

In some embodiments of alternative tobacco products, the effective extraction conditions include an extraction time selected from about 5 minutes to about 60 minutes during step (c).

In some embodiments of alternative tobacco products, the effective extraction conditions include an extraction pH selected from about 6 to about 13 during step (c).

In some embodiments of alternative tobacco products, the effective extraction conditions include an extraction pressure selected from about 1 bar to about 5 bar during step (c).

In some embodiments of alternative tobacco products, the effective extraction conditions cause extraction of the one or more compounds at an extraction yield of at least 25% into the liquid solvent.

In some embodiments, the alternative tobacco product is produced by a process in which in step (d), at least 80% of the liquid solvent mixture is recovered from the second phase. Step (d) may use a falling-film evaporator to recover at least a portion of the solvent from the second phase. Step (d) may use membrane separation to recover at least a portion of the solvent from the second phase.

As an alternative to evaporating the solvent, it is possible to cool the dissolved cabbage solution and then force the solutes out of solution and then filter them out. After filtering, the solvent is heated. At least a portion of the heating may be done utilizing an energy recapture loop. The heated solvent can then be reused as the cabbage extraction solvent.

In such a system, a relatively small portion of the solvent may be evaporated to ensure that there is not a build up of solutes in the solvent over time. In certain embodiments, between about 5 percent by volume and about 90 percent by volume of the solvent are evaporated. This evaporated portion of the solvent may be mixed back into the bulk chilled material.

In some embodiments, the alternative tobacco product is produced by a process further comprising distilling the recovered solvent generated in step (d) to adjust a ratio of the solvent to the anti-solvent within the recovered solvent. Distilling may reduce the ratio of the solvent (e.g., water) to the anti-solvent (e.g., ethanol) within the recovered solvent. Distilling may utilize a bubble-plate distillation column.

The distillation of the ethanol/water/solutes may present some challenges. It is desirable to avoid precipitation as the precipitation may result in clogging of the processing equipment.

In such situations, it is possible to substantially prevent precipitation by evaporating no more than about 90 percent by volume of the solvent at a time as opposed to trying to evaporate all of the solvent such as using a falling film evaporator.

One type of equipment that may be useful in avoiding solute precipitation is a bubble plate distillation column with an enclosed reboiler tank. In certain embodiments, the bubble plate distillation column could be operated under a vacuum. The solvent/extract may be metered into the reboiler tank to ensure that the fluid remains at a desirable level.

The material in the reboiler tank could be pumped through an evaporator at a relatively high flow rate with temperature controlled (between 10 C and 85 C) so that a limited amount of solvent evaporates. The certain embodiments, no more than about 90 percent by volume of the solvent evaporates.

The liquid and gas feed from the reboiler tank is sent to the bottom of the bubble plate column where the liquid falls back to the reboiler and the solvent is separated above the plates.

With the bulk heated liquid going back to the reboiler, the solutes would stay in solution. However, such a process causes the concentration of the solutes in the reboiler to increase over time.

One technique for preventing the undesirable build up of the solutes in the reboiler is to periodically replace the material in the reboiler such as at the end of a cycle where the mixture in the reboiler is predominantly water and most of the ethanol has evaporated. Another technique for preventing the undesirable build up of the solutes in the reboiler is to bleed off a small amount of the mixture from the reboiler.

In some embodiments, the alternative tobacco product is produced by a process in which in step (e), at least 50% of the one or more compounds are removed from the recovered solvent. Step (e) may utilize pH adjustment of the recovered solvent.

In some embodiments, the alternative tobacco product is produced by a process in which the liquid solvent mixture, the recovered solvent, the purified solvent, and/or the condensed recovered solvent is controlled to have a pH from about 6 to about 13.

In some embodiments, the alternative tobacco product is produced by a process in which step (e) utilizes chromatography to remove at least a portion of the one or more compounds from the recovered solvent, and optionally wherein the chromatography utilizes an anion-exchange chromatography resin.

In some embodiments, the alternative tobacco product is produced by a process in which in step (f), at least 90% of the purified recovered solvent is recycled to the extraction vessel.

In some embodiments, the alternative tobacco product is produced by a process in which drying in step (g) utilizes a fluidized-bed dryer or utilizes the extraction vessel operated as a fluidized-bed dryer. The fluidized-bed dryer may utilize a heated dryer gas. The heated dryer gas may be selected from the group consisting of air, CO₂, N₂, Ar, He, and combinations thereof.

In some embodiments, the alternative tobacco product is produced by a process in which in step (g), at least 80% of the residual solvent is removed from the first phase.

In some embodiments, the alternative tobacco product is produced by a process in which in step (h), at least 50% of the vapor of the residual solvent is condensed.

In some embodiments, the alternative tobacco product is produced by a process in which in step (i), at least 90% of the condensed recovered solvent is recycled to the extraction vessel.

In some embodiments, the alternative tobacco product is produced by a batch process. In other embodiments, the alternative tobacco product is produced by a continuous or semi-continuous process.

The alternative tobacco product may further comprise one or more additives. Exemplary additives include, but are not limited to, stimulants, flavorants, nutraceuticals, colorants, texturants, and density modifiers. Additives may be introducing during the process (e.g., added to the starting feedstock or added to a process step), or may be added to the dried extracted biomass solids to produce the final alternative tobacco product.

### BRIEF DESCRIPTION OF THE FIGURES

FIG. 1 is an exemplary block-flow diagram of a process and system for producing an alternative tobacco product from leafy edible biomass, in some variations.

FIG. 2 is an exemplary block-flow diagram of a process and system for utilizing compressed heated air for solvent recovery, and continuously reusing the air.

### DETAILED DESCRIPTION OF EMBODIMENTS OF THE INVENTION

The processes and systems of the present invention will be described in detail by reference to various non-limiting embodiments.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms, except when used in Markush groups. Thus in some embodiments not otherwise explicitly recited, any instance of “comprising” may be replaced by “consisting of” or, alternatively, by “consisting essentially of.”

The present invention provides an economically efficient process and system to convert a leafy edible biomass feedstock into an alternative tobacco product. A wide variety of leafy edible biomass types may be used; the feedstock flexibility is an important feature of the invention. In particular, conventional notions can be broken if the plant matter can be stripped of components that are specific to the leafy edible biomass selected for processing. That is, while a very large number of leafy edible biomass materials are known, to a large extent the underlying fibrous material can be quite similar, containing components such as water, cellulose, hemicellulose, pectin, sugars, lignin, and ash. On the other hand, different edible biomass materials can have fairly specific profiles of compounds such as polyphenols, glucosinolates (causing pungency), flavonoids, carotenoids, sulfites, sulfates, other sulfur compounds, nitrites, nitrates, salts, and metals. It has been recognized in this disclosure that by extracting out the second class of compounds (glucosinolates, etc.), the remaining solid material can be a very effective alternative tobacco product—while at the same time, providing a process that is feedstock-flexible. The feedstock flexibility is important for reaching large commercial scale of alternative tobacco products.

Some variations of the invention provide a process for producing an alternative tobacco product from leafy edible biomass, the process comprising:
(a) providing a biomass feedstock comprising leafy edible biomass, wherein the biomass feedstock optionally contains moisture;
(b) introducing the biomass feedstock and a liquid solvent mixture to an extraction vessel, wherein the liquid solvent mixture contains a solvent and an anti-solvent;
(c) extracting one or more compounds from the biomass feedstock into the liquid solvent mixture, within the extraction vessel operated at effective extraction conditions, to generate a first phase and a second phase, wherein the first phase comprises (i) extracted biomass solids and (ii) residual solvent, and wherein the second phase comprises (i) liquid solvent mixture and (ii) the one or more compounds;
(d) recovering at least a portion of the liquid solvent mixture from the second phase, thereby generating recovered solvent;
(e) removing at least a portion of the one or more compounds from the recovered solvent, thereby generating purified recovered solvent;
(f) recycling the purified recovered solvent back to the extraction vessel;
(g) drying the first phase to remove at least a portion of the residual solvent, thereby generating dried extracted biomass solids and a vapor of the residual solvent;
(h) condensing at least a portion of the vapor of the residual solvent, thereby generating condensed recovered solvent;
(i) recycling the condensed recovered solvent back to the extraction vessel; and
(j) recovering the dried extracted biomass solids as an alternative tobacco product.

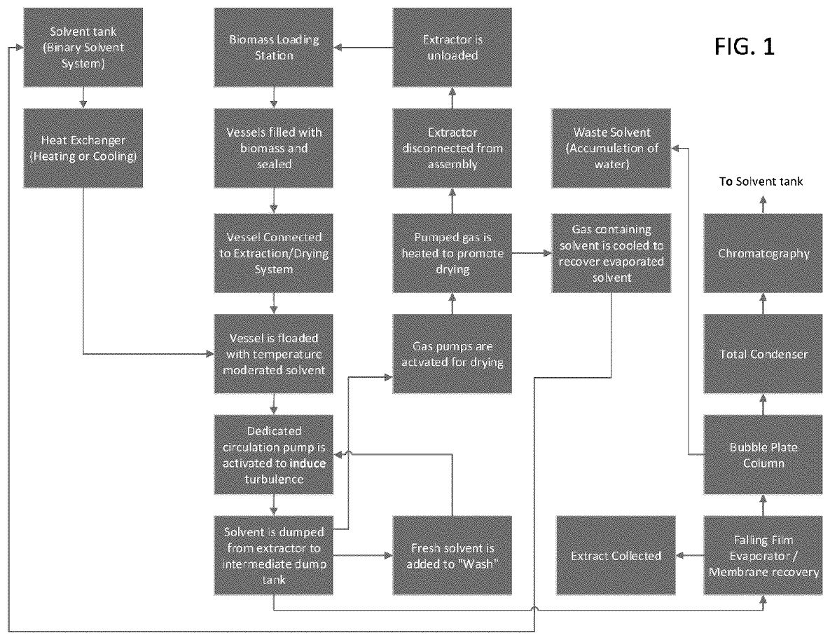

FIG. 1 is an exemplary block-flow diagram of a process and system for producing an alternative tobacco product from leafy edible biomass, in some variations. It is emphasized that FIG. 1 does not limit the scope of the invention, defined by the claims. In describing a process, the blocks of FIG. 1 are process steps. In describing a system, the blocks of FIG. 1 are unit operations, connections between units, or instructions for operating a unit. In FIG. 1, some blocks may be omitted, and other blocks may be used that are not shown. Any blocks may be duplicated in series or in parallel. For example, multiple extraction vessels (extractors) may be employed, typically in parallel, to increase the overall process capacity.

A “leafy edible biomass” refers to a plant material that is both leafy and edible biomass. Biomass is renewable organic material that comes from plants and animals, although in this disclosure, only plant biomass is applicable. “Leafy” means that the biomass structure contains a leaf component. A leaf may be viewed as a solar collector filled with photosynthetic cells. Plants are the only photosynthetic organisms to have leaves, although not all plants have leaves. For example, plants that do not have leaves include moss, liverworts, mushrooms, seaweed, and lichens. “Edible” means that the biomass may be consumed by a human without immediate toxicity. Examples of non-edible (toxic) plants include poison oak, water hemlock, oleander, and rhubarb leaves.

The leafy edible biomass may be selected from the group consisting of cabbage, kale, celery, broccoli, cauliflower, collard greens, lettuce, spinach, hemp, endive, arugula, chicory, and combinations thereof, for example. In certain embodiments, the leafy edible biomass is cabbage.

Note that while the starting feedstock is leafy edible biomass, it is possible to utilize only the leaves from the leafy edible biomass, or to utilize a combination of leaves and other plant components, or even to utilize primarily non-leaf components from the leafy edible biomass. In the example of cabbage as the selected leafy edible biomass, cabbage contains outer leaves, inner leaves, stem, and roots. In some embodiments, only the outer leaves are used. In some embodiments, only the inner leaves are used. In some embodiments, both the outer and inner leaves are used. In some embodiments, the leaves and the core are used; the core contains the step and some inner leaves. In certain embodiments, only the core is used. In certain embodiments, the entire cabbage plant is used.

The leafy edible biomass is obtained from a harvesting operation (e.g., a farm) that grows the leafy edible biomass, or from another entity that handles the biomass between the grower and the user. In some embodiments, the leafy edible biomass is grown on a field that is co-located with the site of the disclosed process. In principle, however, the leafy edible biomass may be obtained from any source worldwide.

The leafy edible biomass, after being harvested, may be washed, such as to remove dirt and living organisms (e.g., worms, bacteria, yeast, etc.). Typically, washing is performed using water, which may be heated water. Washing may be performed at the harvest location, or at the location of the disclosed process, or both of these. Note that washing, if performed, is different than step (c) of the process, using the extraction vessel to extract compounds from the biomass feedstock.

The leafy edible biomass, after being harvested, may be mechanically refined to reduce particle size. The mechanical refining may be before or after washing, or potentially simultaneous with washing. In some embodiments, the mechanical refining shreds the leafy edible biomass, to generate shredded leafy edible biomass. The mechanical refining may employ a commercial vegetable shredder, a grinder, a refiner, or a slicer, for example. The mechanical refining may treat the leafy edible biomass to reduce its average particle length to be about, at least about, or at most about 25 mm, 20 mm, 15 mm, 10 mm, 5 mm, 4 mm, 3 mm, 2.5 mm, 2 mm, 1.5 mm, 1 mm, or 0.5 mm, including any intervening range. The mechanical refining may treat the leafy edible biomass to reduce its average particle width to be about, at least about, or at most about 1 mm, 0.9 mm, 0.8 mm, 0.7 mm, 0.6 mm, 0.5 mm, 0.4 mm, 0.3 mm, 0.2 mm, 0.1 mm, or 0.05 mm, including any intervening range. In certain embodiments, the leafy edible biomass is obtained already having a desirable particle size and therefore does not need to be mechanically treated.

In addition to the leafy edible biomass, the biomass feedstock may contain various levels of water, referred to herein as “moisture”. In some embodiments, the biomass feedstock contains from about 10 wt % water to about 25 wt % water. In various embodiments, the biomass feedstock contains about, at least about, or at most about 0 wt %, 5 wt %, 10 wt %, 15 wt %, 20 wt %, 25 wt %, 30 wt %, 35 wt %, 40 wt %, 45 wt %, or 50 wt %, including any intervening range. In reference to moisture, “wt %” refers to weight of H₂O divided by total weight of biomass feedstock. Moisture included both bound, adsorbed water as well as unbound, bulk water in the feedstock.

In some embodiments, the solvent is water. In some embodiments, the anti-solvent is an alcohol, such as ethanol. Other alcohols may be used as the anti-solvent, such as propanol, n-butanol, or isobutanol. In other embodiments, the anti-solvent is selected from the group consisting of polyols (e.g., ethylene glycol or 1,4-butanediol), organic acids (e.g., acetic acid or citric acid), ketones (e.g., acetone), aldehydes (e.g., acetaldehyde), fatty acids (e.g., caprylic acid), and combinations thereof.

In some embodiments, the extraction vessel has a vertical orientation. A vertical orientation means that the extraction vessel has a vessel height greater than a vessel diameter, and the vessel height is parallel with the direction of gravity. Other vessel orientations may be used, such as horizontal or slanted.

The extraction vessel may contain an inlet filter plate internally situated near the inlet to the extraction vessel, and an outlet filter plate internally situated near the outlet to the extraction vessel. The inlet filter plate and the outlet filter plate allow liquid and vapor to pass but do not allow solid to pass. The filter plates are selected based on the average particle size and particle-size distribution of the extracted biomass solids. This configuration minimizes or prevents extracted biomass solids from leaving the vessel with the liquid solvent.

In some embodiments, the extraction vessel is configured to recirculate the liquid solvent mixture to increase extraction efficiency. By recirculating, the effective residence time of the liquid solvent mixture without increasing the vessel size (and capital cost). Another benefit of recirculating is that the liquid velocity and Reynolds number increases, which in turn enhances mass transfer. In many biomass extractions, mass transfer of a compound being extracted out of the biomass can be the rate-limiting step; therefore, enhancement of mass transfer speeds up the entire extraction process and makes it more efficient, which becomes incredibly important at large commercial scales.

In some embodiments, the effective extraction conditions include an extraction temperature selected from about −80° C. to about 100° C. during step (c). In various embodiments, the extraction temperature is about, at least about, or at most about −80° C., −70° C., −60° C., −50° C., −40° C., −30° C., −20° C., −10° C., 0° C., 10° C., 20° C., 30° C., 40° C., 50° C., 60° C., 70° C., 80° C., 90° C., or 100° C., including any intervening range.

In some embodiments, the effective extraction conditions include an extraction time selected from about 5 minutes to about 60 minutes during step (c). In various embodiments, the extraction time is about, at least about, or at most about 5, 10, 15, 20, 25, 30, 35, 40, 45, 50, 55, or 60 minutes, including any intervening range. In a batch extraction vessel, the extraction time is the batch time. In a continuous extraction vessel, the extraction time is the solid-phase residence time.

In some embodiments, the effective extraction conditions include an extraction pH selected from about 6 to about 13 during step (c). In various embodiments, the extraction pH is about, at least about, or at most about 6, 6.5, 7, 7.5, 8, 8.5, 9, 9.5, 10, 10.5, 11, 11.5, 12, 12.5, or 13, including any intervening range.

In some embodiments, the effective extraction conditions include an extraction pressure selected from about 1 bar to about 5 bar during step (c). In various embodiments, the extraction pressure is about, at least about, or at most about 1, 2, 3, 4, or 5 bar, including any intervening range. Note that “about 1 bar” encompasses ordinary atmospheric pressure at various locations, such can be 1 bar at sea level or can range from about 0.8 bar to about 1.1 bar depending on altitude.

In some embodiments, the effective extraction conditions cause extraction of the one or more compounds at an extraction yield of at least 25%, at least 50%, at least 75%, or at least 90% into the liquid solvent. When more than one compound is extracted, which is typical, the extraction yield of each individual compound may vary, i.e., each compound independent may have an extraction yield of at least 25%, at least 50%, at least 75%, or at least 90% into the liquid solvent.

In some embodiments, in step (d), at least 80%, at least 90%, or at least 95% of the liquid solvent mixture is recovered from the second phase. In various embodiments, at least 50%, 60%, 70%, 75%, 80%, 85%, 90%, 95%, 98%, 99%, 99.5%, 99.9%, or 100% of the liquid solvent mixture is recovered from the second phase.

Because the liquid solvent mixture contains solvent and anti-solvent, the individual recovery of solvent and anti-solvent from the second phase may be the same or different. In various embodiments, at least 50%, 60%, 70%, 75%, 80%, 85%, 90%, 95%, 98%, 99%, 99.5%, 99.9%, or 100% of the solvent (e.g., water) is recovered from the second phase. In these or other embodiments, at least 50%, 60%, 70%, 75%, 80%, 85%, 90%, 95%, 98%, 99%, 99.5%, 99.9%, or 100% of the anti-solvent (e.g., ethanol) is recovered from the second phase.

In some embodiments, step (d) uses a falling-film evaporator to recover at least a portion of the liquid solvent mixture from the second phase. The process mixture (the second phase) flows downwards by gravity as a continuous film. The second phase will create a film along the tube walls, progressing downwards (falling). The liquid solvent mixture evaporates and moves upward relative to the direction of the non-evaporated compounds.

As an alternative to evaporating the solvent, it is possible to cool the dissolved cabbage solution and then force the solutes out of solution and then filter them out. After filtering, the solvent is heated. At least a portion of the heating may be done utilizing an energy recapture loop. The heated solvent can then be reused as the cabbage extraction solvent.

In such a system, a relatively small portion of the solvent may be evaporated to ensure that there is not a build up of solutes in the solvent over time. In certain embodiments, between about 5 percent by volume and about 90 percent by volume of the solvent are evaporated. This evaporated portion of the solvent may be mixed back into the bulk chilled material.

In some embodiments, step (d) uses membrane separation to recover at least a portion of the liquid solvent mixture from the second phase. Various types of membranes may be employed. In membrane separation, the second phase is sent through membrane media that allows the liquid solvent mixture to pass through while retaining the extracted compounds on the media.

The process may further comprise distilling the recovered solvent generated in step (d) to adjust a ratio of the solvent (e.g., water) to the anti-solvent (e.g., ethanol) within the recovered solvent. Distilling may be done to reduce the ratio of the solvent to the anti-solvent within the recovered solvent. In the case of ethanol/water, distilling will increase the ethanol concentration in the overhead product of the distillation column, and will increase the water concentration in the bottom product of the distillation column. Distilling utilizes a bubble-plate distillation column, in certain embodiments.

The distillation of the ethanol/water/solutes may present some challenges. It is desirable to avoid precipitation as the precipitation may result in clogging of the processing equipment.

In such situations, it is possible to substantially prevent precipitation by evaporating no more than about 90 percent by volume of the solvent at a time as opposed to trying to evaporate all of the solvent such as using a falling film evaporator.

One type of equipment that may be useful in avoiding solute precipitation is a bubble plate distillation column with an enclosed reboiler tank. In certain embodiments, the bubble plate distillation column could be operated under a vacuum. The solvent/extract may be metered into the reboiler tank to ensure that the fluid remains at a desirable level.

The material in the reboiler tank could be pumped through an evaporator at a relatively high flow rate with temperature controlled (between 10 C and 85 C) so that a limited amount of solvent evaporates. The certain embodiments, no more than about 90 percent by volume of the solvent evaporates.

The liquid and gas feed from the reboiler tank is sent to the bottom of the bubble plate column where the liquid falls back to the reboiler and the solvent is separated above the plates.

With the bulk heated liquid going back to the reboiler, the solutes would stay in solution. However, such a process causes the concentration of the solutes in the reboiler to increase over time.

One technique for preventing the undesirable build up of the solutes in the reboiler is to periodically replace the material in the reboiler such as at the end of a cycle where the mixture in the reboiler is predominantly water and most of the ethanol has evaporated. Another technique for preventing the undesirable build up of the solutes in the reboiler is to bleed off a small amount of the mixture from the reboiler.

In some embodiments, in step (e), at least 50%, at least 75%, at least 90%, or at least 95% of the one or more compounds are removed from the recovered solvent. In various embodiments, at least 50%, 60%, 70%, 75%, 80%, 85%, 90%, 95%, 98%, 99%, 99.5%, 99.9%, or 100% of the one or more compounds are removed from the recovered solvent.

In some embodiments, step (e) utilizes pH adjustment of the recovered solvent. The pH of the recovered solvent may be adjusted (or controlled) to be in the range of about 6 to about 13, for example. In various embodiments, the pH of the recovered solvent is about, at least about, or at most about 6, 6.5, 7, 7.5, 8, 8.5, 9, 9.5, 10, 10.5, 11, 11.5, 12, 12.5, or 13, including any intervening range. Adjustment of pH may be accomplished using acids, bases, and buffers, as is well-known.

In these or other embodiments, the liquid solvent mixture has a pH adjusted (or controlled) to be in the range of about 6 to about 13. In various embodiments, the pH of the liquid solvent mixture is about, at least about, or at most about 6, 6.5, 7, 7.5, 8, 8.5, 9, 9.5, 10, 10.5, 11, 11.5, 12, 12.5, or 13, including any intervening range.

In these or other embodiments, the purified solvent has a pH adjusted (or controlled) to be in the range of about 6 to about 13. In various embodiments, the pH of the purified solvent is about, at least about, or at most about 6, 6.5, 7, 7.5, 8, 8.5, 9, 9.5, 10, 10.5, 11, 11.5, 12, 12.5, or 13, including any intervening range.

In these or other embodiments, the condensed recovered solvent has a pH adjusted (or controlled) to be in the range of about 6 to about 13. In various embodiments, the pH of the condensed recovered solvent is about, at least about, or at most about 6, 6.5, 7, 7.5, 8, 8.5, 9, 9.5, 10, 10.5, 11, 11.5, 12, 12.5, or 13, including any intervening range.

In some embodiments, step (e) utilizes chromatography to remove at least a portion of the one or more compounds from the recovered solvent. The chromatography may utilize an anion-exchange chromatography resin, for example.

In some embodiments, in step (f), at least 90% of the purified recovered solvent is recycled to the extraction vessel. In various embodiments, at least 50%, 60%, 70%, 80%, 85%, 90%, 95%, 99%, 99.5%, 99.9%, or 100% of the purified recovered solvent is recycled to the extraction vessel. While it is possible to not recycle any purified recovered solvent back to the extraction vessel, that is a less-preferred embodiment.

In some embodiments, drying in step (g) utilizes a separate fluidized-bed dryer. In some embodiments, drying in step (g) utilizes the extraction vessel itself, operated as a fluidized-bed dryer. In other embodiments, drying in step (g) utilizes a forced hot air drum dryer.

The fluidized-bed dryer and/or forced hot air drum dryer preferably utilizes a heated dryer gas. The heated dryer gas may be selected from the group consisting of air, CO₂, N₂, Ar, He, and combinations thereof, for example. In certain embodiments, the heated dryer gas is a mixture of air and nitrogen.

The heated dryer gas may be heated to a temperature from about 50° C. to about 130° C., preferably from about 60° C. to about 120° C., such as from about 70° C. to about 110° C. In various embodiments, the temperature of the heated dryer gas is about, at least about, or at most about 50° C., 60° C., 70° C., 80° C., 90° C., 100° C., 110° C., 120° C., or 130° C., including any intervening range.

The heated dryer gas may be pressurized (i.e., compressed) while remaining in the vapor state. For example, the heated dryer gas may be pressurized to 150 psig (pounds per square inch gauge pressure) to more effectively deliver energy to the biomass, due to increased vapor density. There can be a trade-off between heated dryer gas pressure and the capability of the heated dryer gas to carry the residual solvent away. In various embodiments, the heated dryer gas is compressed to a pressure of about, at least about, or at most about 10 psig, 20 psig, 30 psig, 40 psig, 50 psig, 60 psig, 70 psig, 80 psig, 90 psig, 100 psig, 110 psig, 120 psig, 130 psig, 140 psig, 150 psig, 160 psig, 170 psig, 180 psig, 190 psig, or 200 psig, including any intervening range.

In certain embodiments, the heated dryer gas is at a temperature in the range of about 80-110° C. and a pressure in the range of about 100-150 psig.

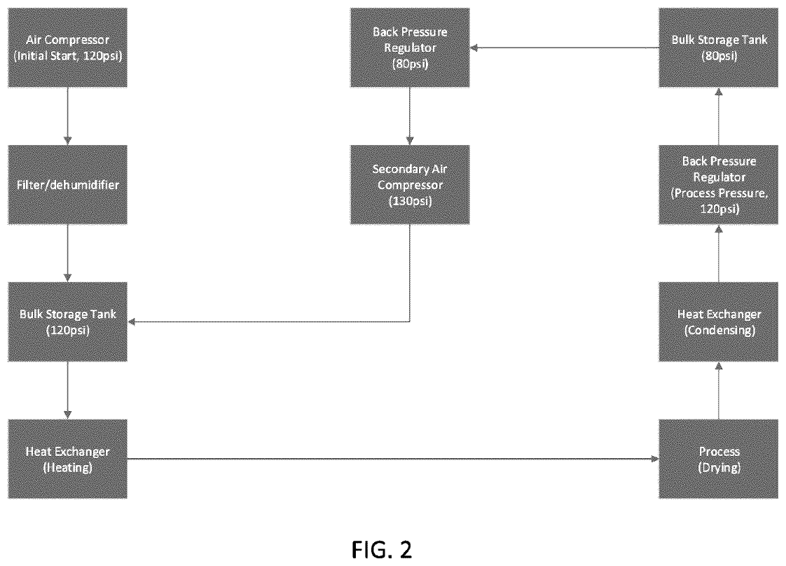

FIG. 2 is an exemplary block-flow diagram of a process and system for utilizing compressed heated dryer gas (which is air, in this drawing) and continuously reusing the air. It is beneficial to continuously reuse the compressed air so that the energy to compress the air is conserved and so that the air will remain cleaner compared to continuously reusing ambient-pressure air. It is emphasized that FIG. 2 does not limit the scope of the invention, defined by the claims. In describing a process, the blocks of FIG. 2 are process steps. In describing a system, the blocks of FIG. 2 are unit operations, connections between units, or instructions for operating a unit. In FIG. 2, some blocks may be omitted, and other blocks may be used that are not shown.

In some embodiments, in step (g), at least 80%, at least 90%, or at least 95% of the residual solvent is removed from the first phase. In various embodiments, at least 50%, 60%, 70%, 80%, 85%, 90%, 95%, 99%, 99.5%, 99.9%, or 100% of the residual solvent is removed from the first phase.

In some embodiments, in step (h), at least 50%, at least 75%, or at least 90% of the vapor of the residual solvent is condensed. In various embodiments, at least 50%, 60%, 70%, 80%, 85%, 90%, 95%, 99%, 99.5%, 99.9%, or 100% of the vapor of the residual solvent is condensed.

[001.33] In some embodiments, in step (i), at least 90% of the condensed recovered solvent is recycled to the extraction vessel. In various embodiments, at least 50%, 60%, 70%, 80%, 85%, 90%, 95%, 99%, 99.5%, 99.9%, or 100% of the condensed recovered solvent is recycled to the extraction vessel. While it is possible to not recycle any condensed recovered solvent back to the extraction vessel, that is a less-preferred embodiment.

The process may be a batch process. Alternatively, the process may be a continuous or semi-continuous process.

The process may further comprise introducing one or more additives to the alternative tobacco product. Additives may be introducing during the process (e.g., added to the starting feedstock or added to a process step), or may be added to the dried extracted biomass solids to produce the final alternative tobacco product. Exemplary additives include, but are not limited to, flavorants, stimulants, dietary supplements, colorants, texturants, nutraceuticals, and pharmaceuticals. Flavorants may include natural or artificial sweeteners, such as cane sugar or stevia. Flavorants may include licorice, mint, cinnamon, coffee, smoke flavor, salt, pepper, spices, etc. Stimulants may include caffeine, nicotine, or cannabinoids, for example. Dietary supplements may include protein or Omega-3 fatty acids, for example. Colorants may include natural food dyes (e.g., carotenoids), for example. Texturants may include starch or cellulose, for example.

Other variations provide a system for producing an alternative tobacco product from leafy edible biomass, the system comprising:
an extraction vessel configured (a) to receive (i) a biomass feedstock comprising leafy edible biomass and (ii) a liquid solvent mixture, wherein the liquid solvent mixture contains a solvent and an anti-solvent; (b) to operate at effective extraction conditions, in an extraction mode, to extract one or more compounds from the biomass feedstock into the liquid solvent mixture, thereby generating a first phase and a second phase, wherein the first phase comprises (i) extracted biomass solids and (ii) residual solvent, and wherein the second phase comprises (i) liquid solvent mixture and (ii) the one or more compounds; and (c) to operate at effective drying conditions, in a drying mode, to remove the residual solvent, thereby generating dried extracted biomass solids and a vapor of the residual solvent;
a solvent recovery unit in flow communication with the extraction vessel, wherein the solvent recovery unit is configured to recover the solvent from the second phase, thereby generating recovered solvent;
a solvent purification unit in flow communication with the solvent recovery unit, wherein the solvent purification unit is configured to remove the one or more compounds from the recovered solvent, thereby generating purified recovered solvent;
a condenser in flow communication with the extraction vessel, wherein the condenser is configured for condensing the vapor of the residual solvent, thereby generating condensed recovered solvent;
a first solvent-recycle line configured to recycle the purified recovered solvent back to the extraction vessel;
a second solvent-recycle line configured to recycle the condensed recovered solvent back to the extraction vessel; and
a system outlet configured to recover the dried extracted biomass solids as an alternative tobacco product.

The volume of each extraction vessel may vary widely, such as from about 1 liter to about 10,000 liters or more. In various embodiments, each extraction vessel has a volume of about, or at least about 1, 10, 50, 100, 200, 250, 300, 350, 400, 450, 500, 600, 700, 800, 900, 1,000, 2,000, 3,000, 4,000, 5,000, 6,000, 7,000, 8,000, 9,000, or 10,000 liters, including any intervening range. When there are multiple extraction vessels, the cumulative vessel volume may be about, or at least about 10,100,500, 1,000, 2,000, 5,000, 10,000, 20,000, 50,000, or 100,000 liters, or more, including any intervening range.

In some systems, each extraction vessel has a vertical orientation, or at least one extraction vessel has a vertical orientation.

Each extraction vessel may contain an inlet filter plate internally situated near the inlet to the extraction vessel, and an outlet filter plate internally situated near the outlet to the extraction vessel. The inlet filter plate and the outlet filter plate allow liquid and vapor to pass but do not allow solid to pass.

Each extraction vessel may be configured to recirculate the liquid solvent mixture to increase extraction efficiency. When there are multiple extraction vessels, the recirculation system may be configured to be common to more than one, or even all, of the extraction vessels, so that for example liquid solvent mixture from each extraction vessel is combined into a common tank and mixed together before being recycled back to extraction vessels.

In some systems, the solvent recovery unit is a falling-film evaporator. In some systems, the solvent recovery unit is a membrane separation unit. In certain systems, both a falling-film evaporator and a membrane separation unit are employed for solvent recovery.

As an alternative to evaporating the solvent, it is possible to cool the dissolved cabbage solution and then force the solutes out of solution and then filter them out. After filtering, the solvent is heated. At least a portion of the heating may be done utilizing an energy recapture loop. The heated solvent can then be reused as the cabbage extraction solvent.

In such a system, a relatively small portion of the solvent may be evaporated to ensure that there is not a build up of solutes in the solvent over time. In certain embodiments, between about 5 percent by volume and about 90 percent by volume of the solvent are evaporated. This evaporated portion of the solvent may be mixed back into the bulk chilled material.

The system may further comprise a distillation unit configured to distill the recovered solvent to adjust a ratio of the solvent (e.g., water) to the anti-solvent (e.g., ethanol) within the recovered solvent. The distillation unit may be a bubble-plate distillation column.

The distillation of the ethanol/water/solutes may present some challenges. It is desirable to avoid precipitation as the precipitation may result in clogging of the processing equipment.

In such situations, it is possible to substantially prevent precipitation by evaporating no more than about 90 percent by volume of the solvent at a time as opposed to trying to evaporate all of the solvent such as using a falling film evaporator.

One type of equipment that may be useful in avoiding solute precipitation is a bubble plate distillation column with an enclosed reboiler tank. In certain embodiments, the bubble plate distillation column could be operated under a vacuum. The solvent/extract may be metered into the reboiler tank to ensure that the fluid remains at a desirable level.

The material in the reboiler tank could be pumped through an evaporator at a relatively high flow rate with temperature controlled (between 10 C and 85 C) so that a limited amount of solvent evaporates. The certain embodiments, no more than about XX percent by volume of the solvent evaporates.

The liquid and gas feed from the reboiler tank is sent to the bottom of the bubble plate column where the liquid falls back to the reboiler and the solvent is separated above the plates.

With the bulk heated liquid going back to the reboiler, the solutes would stay in solution. However, such a process causes the concentration of the solutes in the reboiler to increase over time.

One technique for preventing the undesirable build up of the solutes in the reboiler is to periodically replace the material in the reboiler such as at the end of a cycle where the mixture in the reboiler is predominantly water and most of the ethanol has evaporated. Another technique for preventing the undesirable build up of the solutes in the reboiler is to bleed off a small amount of the mixture from the reboiler.

In some systems, the solvent purification unit is a chromatography unit. The chromatography unit may utilize an anion-exchange chromatography resin, for example.

In some systems, the extraction vessel, when in the drying mode, functions as a fluidized-bed dryer. The fluidized-bed dryer preferably utilizes a heated dryer gas (e.g., heated air). Alternatively, the extraction vessel may be used in conjunction with a separate forced hot air drum dryer.

In some systems, the first solvent-recycle line and the second solvent-recycle line are in separate flow communication with the extraction vessel. In other systems, the first solvent-recycle line and the second solvent-recycle line are in combined flow communication with the extraction vessel.

Typically, the system outlet is an outlet directly from the extraction vessel. In a batch system, the extraction vessel itself, when opened for unloading, becomes the outlet. In a continuous system, the extraction vessel may be configured with a bottom port or release valve to recover the dried extracted biomass solids. Alternatively, the forced hot air drum dryer may be positioned at the outlet of the extraction vessel. In certain embodiments, the dried extracted biomass solids are conveyed from the extraction vessel to another unit, such as a holding vessel, and then recovered from there, in which case the system outlet is not directly from the extraction vessel.

The system may be a batch system. Alternatively, the system may be configured to operate continuously or semi-continuously. Known chemical-engineering principles may be applied to design a continuous or semi-continuous system, including heat exchangers for heating and cooling, containers for intermediate or final storage, pumps, valves, pipes or tubing, and so on.

The system may be automated using a programmable logic controller. Automation is beneficial to monitor and control process conditions for reaction and precipitation, flow rates, and recycle streams, for example. Programmable logic control (PLC) is well-known in modern process industries. Standard safety controls are preferably included in the system.

Any of the systems disclosed herein may be configured to be modular or portable, if desired.

The throughput of a system may vary widely, from small demo or semi-commercial scale to large commercial scale. The designs disclosed herein can be adapted using known chemical-engineering principles to any scale system for production of large, commercial volumes of products.

The selection of the materials of construction for the system will be dependent on the desired properties and should be considered on a case-by-case basis. Someone skilled in the art of material science or metallurgy will be able to select the appropriate materials for the intended use, based on the information provided in this disclosure.

Other variations provide an alternative tobacco product produced from a process comprising:
(a) providing a biomass feedstock comprising leafy edible biomass, wherein the biomass feedstock optionally contains moisture;
(b) introducing the biomass feedstock and a liquid solvent mixture to an extraction vessel, wherein the liquid solvent mixture contains a solvent and an anti-solvent;
(c) extracting one or more compounds from the biomass feedstock into the liquid solvent mixture, within the extraction vessel operated at effective extraction conditions, to generate a first phase and a second phase, wherein the first phase comprises (i) extracted biomass solids and (ii) residual solvent, and wherein the second phase comprises (i) liquid solvent mixture and (ii) the one or more compounds;
(d) recovering at least a portion of the liquid solvent mixture from the second phase, thereby generating recovered solvent;
(e) removing at least a portion of the one or more compounds from the recovered solvent, thereby generating purified recovered solvent;
(f) recycling the purified recovered solvent back to the extraction vessel;
(g) drying the first phase to remove at least a portion of the residual solvent, thereby generating dried extracted biomass solids and a vapor of the residual solvent;
(h) condensing at least a portion of the vapor of the residual solvent, thereby generating condensed recovered solvent;
(i) recycling the condensed recovered solvent back to the extraction vessel; and
(j) recovering the dried extracted biomass solids as an alternative tobacco product.

In some alternative tobacco products, the leafy edible biomass is selected from the group consisting of cabbage, kale, celery, broccoli, cauliflower, collard greens, lettuce, spinach, hemp, endive, arugula, chicory, and combinations thereof. In certain embodiments, the leafy edible biomass is cabbage.

In some embodiments, the alternative tobacco product is produced by a process in which the solvent is water and the anti-solvent is an alcohol, such as ethanol.

In some embodiments, the alternative tobacco product is produced by a process in which the extraction vessel has a vertical orientation.

In some embodiments, the alternative tobacco product is produced by a process in which the extraction vessel contains an inlet filter plate internally situated near the inlet to the extraction vessel, the extraction vessel contains an outlet filter plate internally situated near the outlet to the extraction vessel, and the inlet filter plate and the outlet filter plate allow liquid and vapor to pass but do not allow solid to pass.

In some embodiments, the alternative tobacco product is produced by a process in which the extraction vessel is configured to recirculate the liquid solvent mixture to increase extraction efficiency.

In some embodiments, the alternative tobacco product is produced by a process in which the effective extraction conditions include an extraction temperature selected from about −80° C. to about 100° C. during step (c).

In some embodiments, the alternative tobacco product is produced by a process in which the effective extraction conditions include an extraction time selected from about 5 minutes to about 60 minutes during step (c).

In some embodiments, the alternative tobacco product is produced by a process in which the effective extraction conditions include an extraction pH selected from about 6 to about 13 during step (c).

In some embodiments, the alternative tobacco product is produced by a process in which the effective extraction conditions include an extraction pressure selected from about 1 bar to about 5 bar during step (c).

In some embodiments, the alternative tobacco product is produced by a process in which the effective extraction conditions cause extraction of the one or more compounds at an extraction yield of at least 25% into the liquid solvent.

In some embodiments, the alternative tobacco product is produced by a process in which in step (d), at least 80% of the liquid solvent mixture is recovered from the second phase. Step (d) may use a falling-film evaporator to recover at least a portion of the solvent from the second phase. Step (d) may use membrane separation to recover at least a portion of the solvent from the second phase.

As an alternative to evaporating the solvent, it is possible to cool the dissolved cabbage solution and then force the solutes out of solution and then filter them out. After filtering, the solvent is heated. At least a portion of the heating may be done utilizing an energy recapture loop. The heated solvent can then be reused as the cabbage extraction solvent.

In such a system, a relatively small portion of the solvent may be evaporated to ensure that there is not a build up of solutes in the solvent over time. In certain embodiments, between about 5 percent by volume and about 90 percent by volume of the solvent are evaporated. This evaporated portion of the solvent may be mixed back into the bulk chilled material.

In some embodiments, the alternative tobacco product is produced by a process further comprising distilling the recovered solvent generated in step (d) to adjust a ratio of the solvent to the anti-solvent within the recovered solvent. Distilling may reduce the ratio of the solvent (e.g., water) to the anti-solvent (e.g., ethanol) within the recovered solvent. Distilling may utilize a bubble-plate distillation column.

The distillation of the ethanol/water/solutes may present some challenges. It is desirable to avoid precipitation as the precipitation may result in clogging of the processing equipment.

In such situations, it is possible to substantially prevent precipitation by evaporating no more than about 90 percent by volume of the solvent at a time as opposed to trying to evaporate all of the solvent such as using a falling film evaporator.

One type of equipment that may be useful in avoiding solute precipitation is a bubble plate distillation column with an enclosed reboiler tank. In certain embodiments, the bubble plate distillation column could be operated under a vacuum. The solvent/extract may be metered into the reboiler tank to ensure that the fluid remains at a desirable level.

The material in the reboiler tank could be pumped through an evaporator at a relatively high flow rate with temperature controlled (between 10 C and 85 C) so that a limited amount of solvent evaporates. The certain embodiments, no more than about XX percent by volume of the solvent evaporates.

The liquid and gas feed from the reboiler tank is sent to the bottom of the bubble plate column where the liquid falls back to the reboiler and the solvent is separated above the plates.

With the bulk heated liquid going back to the reboiler, the solutes would stay in solution. However, such a process causes the concentration of the solutes in the reboiler to increase over time.

One technique for preventing the undesirable build up of the solutes in the reboiler is to periodically replace the material in the reboiler such as at the end of a cycle where the mixture in the reboiler is predominantly water and most of the ethanol has evaporated. Another technique for preventing the undesirable build up of the solutes in the reboiler is to bleed off a small amount of the mixture from the reboiler.

In some embodiments, the alternative tobacco product is produced by a process in which in step (e), at least 50% of the one or more compounds are removed from the recovered solvent. Step (e) may utilize pH adjustment of the recovered solvent.

In some embodiments, the alternative tobacco product is produced by a process in which the liquid solvent mixture, the recovered solvent, the purified solvent, and/or the condensed recovered solvent is controlled to have a pH from about 6 to about 13.

In some embodiments, the alternative tobacco product is produced by a process in which step (e) utilizes chromatography to remove at least a portion of the one or more compounds from the recovered solvent, and optionally wherein the chromatography utilizes an anion-exchange chromatography resin.

In some embodiments, the alternative tobacco product is produced by a process in which in step (f), at least 90% of the purified recovered solvent is recycled to the extraction vessel.

In some embodiments, the alternative tobacco product is produced by a process in which drying in step (g) utilizes a fluidized-bed dryer or utilizes the extraction vessel operated as a fluidized-bed dryer or utilizes a forced hot air drum dryer. The fluidized-bed dryer may utilize a heated dryer gas. The heated dryer gas may be selected from the group consisting of air, CO₂, N₂, Ar, He, and combinations thereof.

In some embodiments, the alternative tobacco product is produced by a process in which in step (g), at least 80% of the residual solvent is removed from the first phase.

In some embodiments, the alternative tobacco product is produced by a process in which in step (h), at least 50% of the vapor of the residual solvent is condensed.

In some embodiments, the alternative tobacco product is produced by a process in which in step (i), at least 90% of the condensed recovered solvent is recycled to the extraction vessel.

In some embodiments, the alternative tobacco product is produced by a batch process. In other embodiments, the alternative tobacco product is produced by a continuous or semi-continuous process.

The alternative tobacco product may further comprise one or more additives. Exemplary additives include, but are not limited to, flavorants, stimulants, dietary supplements, colorants, texturants, nutraceuticals, and pharmaceuticals. Flavorants may include natural or artificial sweeteners, such as cane sugar or stevia. Flavorants may include licorice, mint, cinnamon, coffee, smoke flavor, salt, pepper, spices, etc. Stimulants may include caffeine, nicotine, or cannabinoids, for example. Dietary supplements may include protein or Omega-3 fatty acids, for example. Colorants may include natural food dyes (e.g., carotenoids), for example. Texturants may include starch or cellulose, for example.

The alternative tobacco product may be a smokeless chewing product, provided in boxes, bags, dip pouches, small containers, and so on.

In this detailed description, reference has been made to multiple embodiments and to the accompanying drawings in which are shown by way of illustration specific exemplary embodiments of the invention. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein.

The embodiments, variations, and figures described above should provide an indication of the utility and versatility of the present invention. Other embodiments that do not provide all of the features and advantages set forth herein may also be utilized, without departing from the spirit and scope of the present invention. Such modifications and variations are considered to be within the scope of the invention defined by the claims.

### EXAMPLES

Variations of the disclosed technology will now be described as a set of specific, non-limiting examples. In these examples, the leafy edible biomass is shredded cabbage containing about 10-25 wt % moisture. The scaled-up process in these examples utilizes a combination of several different unit operations to achieve an optimum result. The unit operations include extraction, affinity chromatography, pH adjustment, solvent recovery, distillation, and drying. Each description of a unit operation forms an example, and the combined process forms an integrated, overall example.

Extraction: Extraction is the main process in which undesirable compounds are removed from the plant biomass (shredded cabbage). Many of the compounds that are removed are complex organic flavonoids that give certain plants (including, but not limited to, cabbage) their smell and/or taste. There is a delicate balance that needs to take place for the choice of solvent and anti-solvent. For this example, water is selected as the solvent and ethanol is selected as the anti-solvent. From an economics perspective, there is a need to limit the number of extracted constituents from the biomass and this done by modifying the ratio of solvent to anti-solvent, the extraction temperature, and the extraction pH.

Multiple extraction vessels are utilized, each having a working volume of 445 liters. This volume is chosen so that each extraction vessel can accommodate an industry-standard C48 carton box worth of biomass (about 220 pounds). Fitting a whole C48 container of feed material into one extraction vessel has the added advantage of making lot traceability easier.

Each extraction vessel is oriented vertically and is on a rotating frame. The purpose of the rotating frame is so that the dried extracted biomass solids can be recovered easily by a single operator, in a batch process.

Each extraction vessel also has two stainless steel fritted filter plates at either end to keep the biomass contained in one location, while allowing solvent and gas to pass freely through the biomass.

To induce turbulent flow to increase extraction efficiency, each extraction vessel is configured with a dedicated pump so that once the extraction vessel is full of liquid, the pump pulls from the bottom and recirculates the liquid to the top without introducing new solvent. This configuration is expected to achieve a higher solubility of undesirable compounds and decrease the overall solvent consumption.

Affinity Chromatography: It is preferred to recover and reuse the solvent mixture, especially the ethanol anti-solvent. Some or all of the undesirable compounds are preferably removed from the solvent after each use. If the extracted impurities are left in the solvent mixture, then the extraction effectiveness will decrease over time, as the solvent mixture is used over and over. Large cylinders are used to hold chromatography media to absorb sulfur-containing compounds, utilizing a strong base anion-exchange resin. It is hypothesized that most of the flavonoids in cabbage are in a negative state due to sulfur's ability to bind to many other organic compounds. Thus, an anion-exchange resin that switches between acid and base forms, to absorb and desorb the compounds, is preferred. In this example, a macroporous type I strong base anion-exchange resin is selected. Although the sequence of steps may be varied from that shown in FIG. 1, for the sake of efficient chromatography, it is usually preferred to employ chromatography after the bulk extract has been removed (from the falling-film evaporator and/or membrane system) and after the distillation of the solvent mixture.

pH Adjustment: Another way to reduce the desirables extracted is to modify the pH of the solvent mixture so that the sulfur-containing compounds have a different electronegativity. An adjusted electronegativity will alter the solubility of a sulfur-containing compound. This, in turn, can adjust the extent of extraction into the liquid solvent during the extraction step, and/or can enable easier separation from the solvent mixture during solvent recovery.

Solvent Recovery: A falling-film evaporator is utilized to recover a majority of the solvent from the extract. As referenced above, it is possible to other techniques for recovering the solvent. Alternatively, or additionally, in an effort to drive down energy costs, a membrane system can be used to recover a bulk of the solvent from the extract so that the amount of solvent needing to be vaporized is severely decreased or even eliminated (in the case where a membrane system recovers a sufficient quantity of solvent).

Distillation: Another problem is the increase in concentration of water over time in the bulk extraction mixture, from the falling-film evaporator or membrane system. This additional water comes from the moisture of the input shredded cabbage itself. Without readjusting the solvent ratio, the extraction performance of the biomass will be decreased over time. To overcome this problem, a bubble-plate distillation column is employed, so that the concentration of ethanol can be readjusted or changed completely, if desired. In a bubble-plate distillation column fed with a water/ethanol mixture, the top product will be rich in ethanol and the bottom product will be rich in water, since ethanol boils at 78° C. while water boils at 100° C., both at a pressure of 1 bar. The bottom product is “waste solvent” in FIG. 1 and goes to a waste-solvent tank. As described in more detail above, it is also possible to use a bubble plate distillation column with an enclosed reboiler tank as such a system reduces the potential of precipitation.

Drying: The final step in creating a consumer-ready product is to remove any residual solvent so that the product is brought to a relatively dry state. In this example, drying is accomplished using the same extraction vessels, operated as fluidized beds in which there is both upflow and downflow of the solid phase, dried using a heated dryer gas as fluidization medium. Fluidized-bed drying is selected because, with a high enough gas velocity, the solid material in the vessel will be tossed around and allowed to dry evenly. In this example, the heated dryer gas is air, heated to about 70-110° C. prior to entry into the fluidized-bed dryer. The heated dryer gas coming into the vessel is preheated to just below the evaporation temperature of ethanol at the applicable ambient pressure (e.g., 0.8 bar in Denver, Colorado). Optimization of heated dryer gas temperature is believed to be important to avoid cell rupturing (in the target product, the extracted biomass solids) when the ethanol is vaporizing from a liquid to a gas. As referenced above, drying may also be accomplished using the forced hot air drum dryer.

As the dryer gas is removed from the fluidized-bed dryer (extraction vessel) or the force hot air drum dryer, the vapor is sent to a dehumidifier to recovery all of the solvent contained in the vapor. This step allows for dramatically reduced ongoing solvent consumable costs.

Finally, the extraction vessel is opened up and unloaded, to recover the dried biomass solids as an alternative tobacco product.

1. A process for producing an alternative tobacco product from leafy edible biomass, wherein the process comprises:
(a) providing a biomass feedstock comprising leafy edible biomass, wherein the biomass feedstock optionally contains moisture;
(b) introducing the biomass feedstock and a liquid solvent mixture to an extraction vessel, wherein the liquid solvent mixture contains a solvent and an anti-solvent;
(c) extracting one or more compounds from the biomass feedstock into the liquid solvent mixture, within the extraction vessel operated at effective extraction conditions, to generate a first phase and a second phase, wherein the first phase comprises (i) extracted biomass solids and (ii) residual solvent, and wherein the second phase comprises (i) a portion of the liquid solvent mixture and (ii) the one or more compounds;
(d) recovering at least a portion of the liquid solvent mixture from the second phase, thereby generating recovered solvent;
(e) removing at least a portion of the one or more compounds from the recovered solvent, thereby generating purified recovered solvent;
(f) recycling the purified recovered solvent back to the extraction vessel;
(g) drying the first phase to remove at least a portion of the residual solvent, thereby generating dried extracted biomass solids and a vapor of the residual solvent;
(h) condensing at least a portion of the vapor of the residual solvent, thereby generating condensed recovered solvent;
(i) recycling the condensed recovered solvent back to the extraction vessel; and
(j) recovering the dried extracted biomass solids as an alternative tobacco product.

2. The process of claim 1, wherein the leafy edible biomass is selected from the group consisting of cabbage, kale, celery, broccoli, cauliflower, collard greens, lettuce, spinach, hemp, endive, arugula, chicory, and combinations thereof.

3. The process of claim 1, wherein the solvent is water and wherein the anti-solvent is an alcohol.

4. The process of claim 1, wherein the extraction vessel contains an inlet filter plate internally situated near the inlet to the extraction vessel, wherein the extraction vessel contains an outlet filter plate internally situated near the outlet to the extraction vessel, and wherein the inlet filter plate and the outlet filter plate allow liquid and vapor to pass but do not allow solid to pass.

5. The process of claim 1, wherein the extraction vessel is configured to recirculate the liquid solvent mixture to increase extraction efficiency.

6. The process of claim 1, wherein the effective extraction conditions include at least one of:
an extraction temperature selected from about −80° C. to about 100° C. during step (c).
an extraction time selected from about 5 minutes to about 60 minutes during step (c)
an extraction pH selected from about 6 to about 13 during step (c); and
an extraction pressure selected from about 1 bar to about 5 bar during step (c).

7. The process of claim 1, wherein the effective extraction conditions cause extraction of the one or more compounds at an extraction yield of at least 90% into the liquid solvent.

8. The process of claim 1, wherein in step (d), at least 95% of the liquid solvent mixture is recovered from the second phase.

9. The process of claim 1, wherein step (d) uses at least one of a falling-film evaporator, a membrane separator or a cooling and filtering process to recover the at least a portion of the solvent from the second phase.

10. The process of claim 1, wherein the process further comprises distilling the recovered solvent generated in step (d) to adjust a ratio of the solvent to the anti-solvent within the recovered solvent, wherein the distilling reduces the ratio of the solvent to the anti-solvent within the recovered solvent and wherein the distilling utilizes a bubble-plate distillation column that may be used alone or in conjunction with a reboiler tank.

11. The process of claim 1, wherein in step (e), at least 95% of the one or more compounds are removed from the recovered solvent and wherein step (e) utilizes pH adjustment of the recovered solvent.

12. The process of claim 1, wherein the liquid solvent mixture has a pH from about 6 to about 13, wherein the recovered solvent has a pH from about 6 to about 13, wherein the purified solvent has a pH from about 6 to about 13 and wherein the condensed recovered solvent has a pH from about 6 to about 13.

13. The process of claim 1, wherein step (e) utilizes chromatography to remove the at least a portion of the one or more compounds from the recovered solvent.

14. The process of claim 1, wherein in step (f), at least 90% of the purified recovered solvent is recycled to the extraction vessel.

15. The process of claim 1, wherein the drying in step (g) utilizes at least one of a fluidized-bed dryer, the extraction vessel operated as a fluidized-bed dryer and a forced hot air drum dryer and wherein in step (g), at least 95% of the residual solvent is removed from the first phase.

16. The process of claim 1, wherein in step (h), at least 90% of the vapor of the residual solvent is condensed.

17. The process of claim 1, wherein in step (i), at least 90% of the condensed recovered solvent is recycled to the extraction vessel.

18. A system for producing an alternative tobacco product from leafy edible biomass, wherein the system comprises:
an extraction vessel configured (a) to receive (i) a biomass feedstock comprising leafy edible biomass and (ii) a liquid solvent mixture, wherein the liquid solvent mixture contains a solvent and an anti-solvent; (b) to operate at effective extraction conditions, in an extraction mode, to extract one or more compounds from the biomass feedstock into the liquid solvent mixture, thereby generating a first phase and a second phase, wherein the first phase comprises (i) extracted biomass solids and (ii) residual solvent, and wherein the second phase comprises (i) a portion of the liquid solvent mixture and (ii) the one or more compounds; and (c) to operate at effective drying conditions, in a drying mode, to remove the residual solvent, thereby generating dried extracted biomass solids and a vapor of the residual solvent;
a solvent recovery unit in flow communication with the extraction vessel, wherein the solvent recovery unit is configured to recover the solvent from the second phase, thereby generating recovered solvent;
a solvent purification unit in flow communication with the solvent recovery unit, wherein the solvent purification unit is configured to remove the one or more compounds from the recovered solvent, thereby generating purified recovered solvent;
a condenser in flow communication with the extraction vessel, wherein the condenser is configured for condensing the vapor of the residual solvent, thereby generating condensed recovered solvent;
a first solvent-recycle line configured to recycle the purified recovered solvent back to the extraction vessel;
a second solvent-recycle line configured to recycle the condensed recovered solvent back to the extraction vessel; and
a system outlet configured to recover the dried extracted biomass solids as an alternative tobacco product.

19. The system of claim 18, wherein the leafy edible biomass is selected from the group consisting of cabbage, kale, celery, broccoli, cauliflower, collard greens, lettuce, spinach, hemp, endive, arugula, chicory, and combinations thereof.

20. An alternative tobacco product produced from a process comprising:
(a) providing a biomass feedstock comprising leafy edible biomass, wherein the biomass feedstock optionally contains moisture;
(b) introducing the biomass feedstock and a liquid solvent mixture to an extraction vessel, wherein the liquid solvent mixture contains a solvent and an anti-solvent;
(c) extracting one or more compounds from the biomass feedstock into the liquid solvent mixture, within the extraction vessel operated at effective extraction conditions, to generate a first phase and a second phase, wherein the first phase comprises (i) extracted biomass solids and (ii) residual solvent, and wherein the second phase comprises (i) a portion of the liquid solvent mixture and (ii) the one or more compounds;
(d) recovering at least a portion of the liquid solvent mixture from the second phase, thereby generating recovered solvent;
(e) removing at least a portion of the one or more compounds from the recovered solvent, thereby generating purified recovered solvent;
(f) recycling the purified recovered solvent back to the extraction vessel;
(g) drying the first phase to remove at least a portion of the residual solvent, thereby generating dried extracted biomass solids and a vapor of the residual solvent;
(h) condensing at least a portion of the vapor of the residual solvent, thereby generating condensed recovered solvent;
(i) recycling the condensed recovered solvent back to the extraction vessel; and
(j) recovering the dried extracted biomass solids as an alternative tobacco product.

21. The alternative tobacco product of claim 20, wherein the leafy edible biomass is selected from the group consisting of cabbage, kale, celery, broccoli, cauliflower, collard greens, lettuce, spinach, hemp, endive, arugula, chicory, and combinations thereof.
